(19) United States
(12) Patent Application Publication
(10) Pub. No.: US 2007/0117600 A1
(43) Pub. Date: May 24, 2007

(54) Flexible hinge for portable electronic device

(76) Inventors: William H. Robertson JR., Fort Lauderdale, FL (US); Matthew J. Johnson, Plantation, FL (US); Amy C. Mannisto, Sunrise, FL (US); Michael J. Page, Fort Lauderdale, FL (US); Monika R. Wolf, Coral Springs, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/285,562

(22) Filed: Nov. 21, 2005

(51) Int. Cl. H04M 1/00

(52) U.S. Cl. 455/575.3; 455/575.1

(57) ABSTRACT

The invention concerns a flip-type portable electronic device (100). The device can include a base portion (112), a flip portion (110) and a flexible hinge (114) that can couple the flip portion to the base portion. In one arrangement, the flexible hinge can include a plurality of interlocking links (115) that rotate about a plurality of axles (122) contained within the flexible hinge, and the interlocking links may rotate independently of one another. The rotation of the interlocking links can allow the flip portion to rotate with respect to the base portion.

### BACKGROUND OF THE INVENTION

1. Field of the Invention

The present invention concerns portable electronic devices and more particularly, hinges for such devices.

2. Description of the Related Art

In recent years, the use of portable electronic devices, such as cellular telephones and portable digital assistants, has exploded. Many of these devices include two basic sections. In particular, many cellular telephones are clam-shell shaped and include a base portion and a flip portion. Typically, the base portion includes a keypad and other control buttons, while the flip portion contains one or more displays and speakers. The flip portion and the base portion are generally coupled together through a snap hinge mechanism.

Generally, the snap hinge mechanism snaps the flip portion shut when the flip portion is moved towards the base portion. Similarly, the snap hinge mechanism snaps the flip portion open when the flip portion is opened and moved away from the base portion. Although convenient, the flip portion is unable to remain in any position other than in a completely closed or a completely open one. Moreover, the sudden snapping motion puts undue stresses on the flip and base portions of the clam-shell phone.

### SUMMARY OF THE INVENTION

The present invention concerns a flip-type portable electronic device. The device can include a base portion, a flip portion and a flexible hinge that can couple the flip portion to the base portion. In one arrangement, the flexible hinge can include a plurality of interlocking links that may rotate about a plurality of axles contained within the flexible hinge. The interlocking links may also rotate independently of one another. The rotation of the interlocking links can allow the flip portion to rotate with respect to the base portion.

As an example, the flip portion may remain in any one of a plurality of positions as it rotates with respect to the base portion. In addition, each position that the flip portion may remain in can correspond to one of a plurality of dwell positions that each link rotates between. As another example, the dwell positions may be either pre-slope positions or post-slop positions. Moreover, a feedback detent can be produced when the link rotates between a pre-slope dwell position and a post-slope dwell position.

In another arrangement, the flip-type electronic device can be a mobile communications unit, and the base portion may include a keypad and the flip portion may include a display. As another example, in a first state of rotation, one end of the flip portion may rest or may be positioned against the base portion, and an opening can be formed between a second end of the flip portion and the base portion that can receive a mechanism that holds the portable electronic device.

The flexible hinge can further include a plurality of cam springs and cams, and the cam springs can be coupled to the axles and the cams. Further, the cam springs can be coupled to the cams such that a cam spring is secured to two first cams and rides along a cam active surface of two second cams. In particular, the first cams may be positioned in a first link, and the second cams may be positioned in a second link. The cam active surfaces may include a ridge over which the cam springs ride, and a first end and a second end of the cam springs may be forced towards one another as the cam springs ride over the ridges of the cam active surfaces.

In yet another arrangement, ends of the axles may be contained within cavities of the links, and the links can rotate around the axles contained within their cavities. The links may also include a shell portion and an engagement portion, and the engagement portion of a first link can fit within the shell portion of a second link. As an example but without limitation, the flip portion may rotate about 155 degrees with respect to the base portion, and each link may rotate about 31 degrees.

The present invention also concerns a flexible hinge. The hinge can include a plurality of links, and the links can include a shell portion and an engagement portion. The engagement portion of a first link can fit within the shell portion of a second link. The hinge can also include a plurality of cams having cam active surfaces and a plurality of cam springs coupled to the links and to a plurality of axles. The cam springs can ride along the cam active surfaces. In one arrangement, the links can rotate around the axles a number of degrees as the cam springs ride along the cam active surfaces, and the rotation of the links can enable the links to move between open and closed positions. As an example, the cams can include an aperture, and the cam springs can be positioned within the apertures of the cams.

The present invention also concerns a flip-type portable electronic device. The device can include a base portion, a flip portion and a flexible hinge that can couple the flip portion to the base portion and can enable the flip portion to rotate a number of degrees with respect to the base portion. As an example, the flexible hinge can have a plurality of links in which each link may rotate a number of degrees such that the total sum of the degrees of rotation of the links can at least substantially equal the number of degrees that the flip portion may rotate. As another example, the base portion can include a keypad, and the flip portion can include a display.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates an example of a flip-type portable electronic device in accordance with an embodiment of the inventive arrangements;

FIG. 2 illustrates an example of a flexible hinge of the portable electronic device of FIG. 1 with the device in a closed position in accordance with an embodiment of the inventive arrangements;

FIG. 3 illustrates an example of a flexible hinge of the portable electronic device of FIG. 1 with the device in an open position in accordance with an embodiment of the inventive arrangements;

FIG. 4 illustrates an example of several internal components of the flexible hinge of FIGS. 2 and 3 in accordance with an embodiment of the inventive arrangements;

FIG. 5 illustrates an example of several cams and cam springs in accordance with an embodiment of the inventive arrangements; and

FIG. 6 illustrates an example of a cam in accordance with an embodiment of the inventive arrangements;

### DETAILED DESCRIPTION OF THE INVENTION

While the specification concludes with claims defining the features of the invention that are regarded as novel, it is believed that the invention will be better understood from a consideration of the following description in conjunction with the drawings, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The terms “coupled” and “engagement,” as used herein, are defined as connected, although not necessarily directly, and not necessarily mechanically.

The present invention concerns a flip-type portable electronic device that can include a base portion, a flip portion and a flexible hinge that may couple the flip portion to the base portion. The flexible hinge flexible hinge can include a plurality of interlocking links that can rotate about a plurality of axles contained within the flexible hinge, and the interlocking links may rotate independently of one another. The rotation of the interlocking links can allow the flip portion to rotate with respect to the base portion.

In one arrangement, the flip portion may remain in any one of a plurality of positions as it rotates with respect to the base portion. Each position that the flip portion may remain in can correspond to one of a plurality of dwell positions that each link rotates between. As such, a user may rotate the flip portion to any desired position with respect to the base portion.

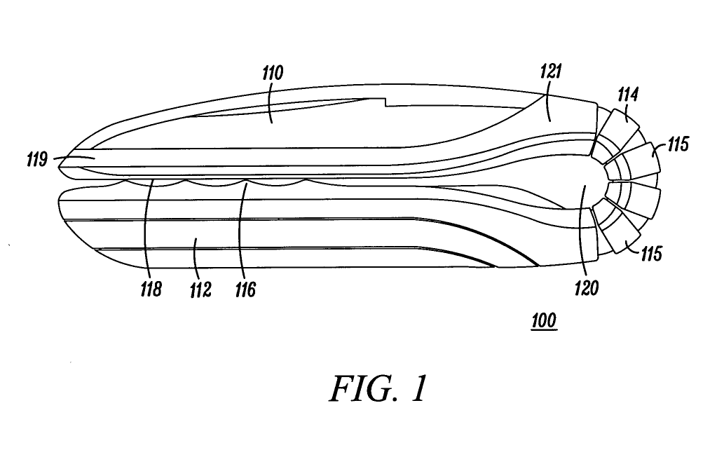

Referring to FIG. 1, an example of a flip-type portable electronic device 100 is shown. In this example, the portable electronic device 100 may be a flip-type mobile communications unit, such as a cellular phone, although the invention is not so limited. In one embodiment, the device 100 can include a flip portion 110, a base portion 112 and a flexible hinge 114, which can couple the flip portion 110 to the base portion 112. The flexible hinge 114 can include one or more links 115, which can be interlocking members, as shown. As will be explained below, the interlocking links 115 may rotate about a plurality of axles (not shown here) contained within the flexible hinge 114 and the interlocking links 115 may rotate independently of one another. The rotation of the interlocking links 115 can allow the flip portion 110 to rotate with respect to the base portion 112. In one arrangement, the base portion 112 can include a keypad 116, and the flip portion 110 can have one or more displays 118.

In this example, the flip portion 110 may be in a first state of rotation in which at least one end 119 of the flip portion 110 may rest against the base portion 112, and an opening 120 may be formed between a second end 121 of the flip portion 110 and the base portion 112. This opening 120 can receive a mechanism (not shown) that can hold the device 100. For example, the flip portion 110 and the base portion 112 may be closed around a belt or a purse strap, for example, and the belt or strap can hold the device 100 in place.

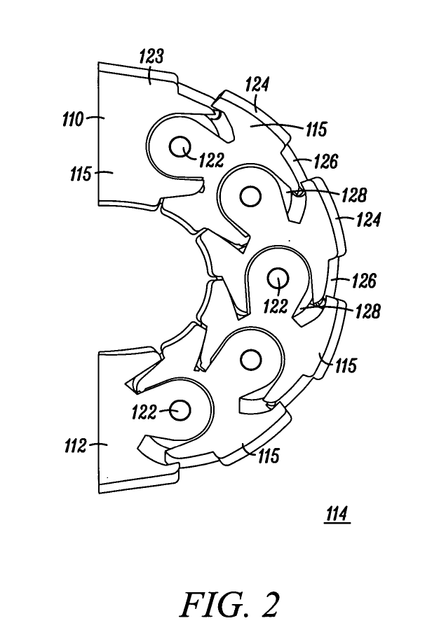

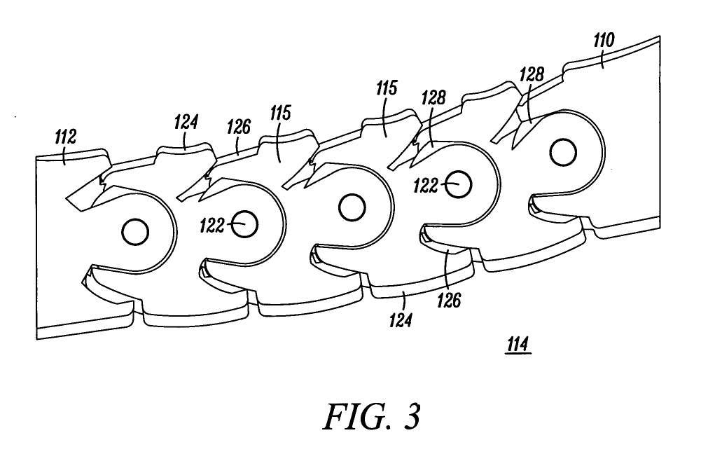

Referring to FIG. 2, a cross-sectional view of the flexible hinge 114 in a closed position is shown. This closed position refers to the end 119 of the flip portion 110 resting or sitting on the base portion 112 (see FIG. 1). The links 115 can rotate about axles 122 for a number of degrees. As an example, a segment 123 of the flip portion 110 can be considered a link 115, too. In particular, the links 115 can include a shell portion 124 and an engagement portion 126, and the engagement portion 126 of a first link 115 can slide into and fit within the shell portion 124 of a second link 115. The interlocking nature of the links 115 can also be seen in FIG. 1. This feature can help the links 115 rotate about the axles 122. A number of cams 128 can be positioned in the links 115, and their operation will be described below. An example of the flexible hinge 114 in an open position is shown in FIG. 3. For purposes of the invention, an open position can be any position of the device 100 in which the end 119 of the flip portion 110 (see FIG. 1) is lifted off of the base portion 112.

In one arrangement, the flip portion 110 may remain in any one of a plurality of portions as it rotates with respect to the base portion 112. As an example, each position that the flip portion 110 may remain in can correspond to one of a plurality of dwell positions that each link 115 can rotate between. For example, the flip portion 110 may rotate about 155 degrees with respect to the base portion 112. In accordance with an embodiment of the inventive arrangements, the flip portion 110 may remain in any fractional degree value of this 155 degree rotation, and these values may correspond to positions that the links 115 can rotate between.

For example, the links 115 may rotate from zero degrees to about thirty-one degrees. In particular, focusing on FIG. 2, the engagement portions 126 of the links 115 can be at a first position, such as zero degrees, which may also be a dwell position. As the flip portion 110 is moved away from the base portion 112, the engagement portions 126 can slide into the shell portions 124, which is shown in FIG. 3. During this process, each of the links 115 may rotate to a second position, such as about thirty-one degrees, which can also be a dwell position. In addition, the flip portion 110 may stop at any position during its rotation. For example, three links 115 may rotate their full range of motion, such as roughly thirty-one degrees, and the flip portion 110 may be kept in this position. It is important to note that the links 115 are not limited to being rotated in a sequential fashion from one end to another, as any suitable number of the links 115 may be rotated any suitable number of degrees at any suitable time.

In one arrangement, the links 115 can rotate a number of degrees such that the total sum of the degrees of rotation of the links 115 at least substantially equals the number of degrees that the flip portion 110 can rotate. For example, each of the links 115 can rotate about thirty-one degrees, and the sum of the five links 115 (including the segment 123 of the flip portion 110) can at least substantially equal the number of degrees that the flip portion 110 can rotate, which in this example is about 155 degrees. For purposes of the invention, the term “about thirty-one degrees” can include thirty-one degrees plus or minus ten degrees. In addition, the term “about 155 degrees” can include 155 degrees plus or minus fifteen degrees.

Of course, the invention is in no way limited to having five links 115 and their ranges of motion are not limited to thirty-one degrees. Moreover, the full range of motion of the flip portion 110 is not limited to 155 degrees, as the flip portion 110 can have any other suitable range of motion.

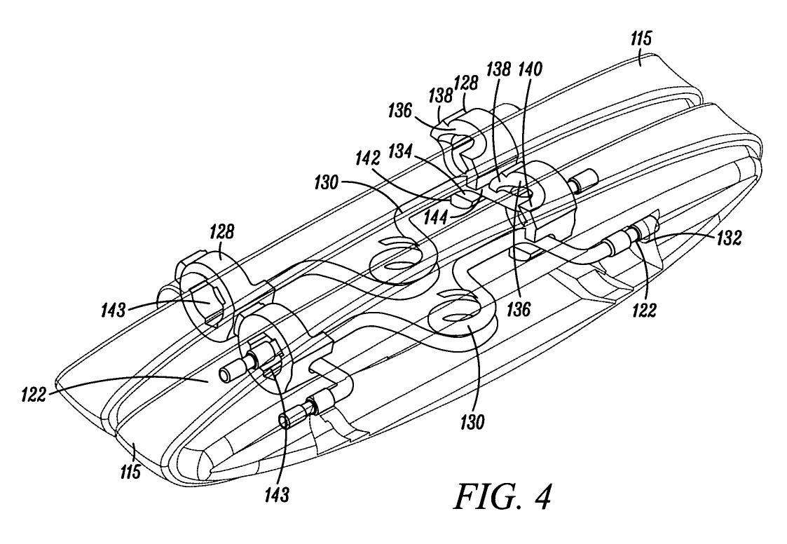

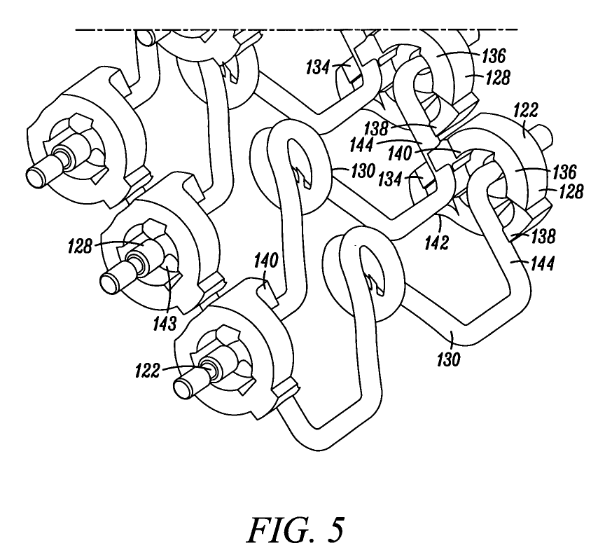

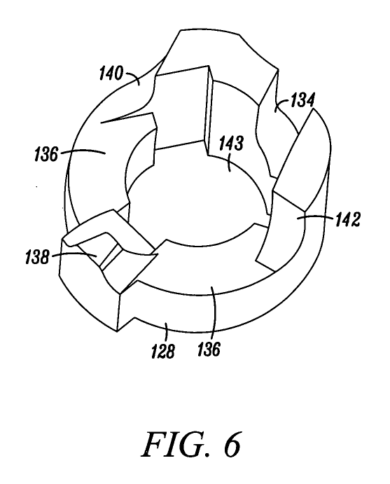

Referring to FIG. 4, several links 115, axles 122 and cams 128 are shown. The links 115 are shown in transparency to illustrate the components contained therein. The links 115 may also include one or more cam springs 130, which can be coupled to the axles 122. In one embodiment, the ends of the axles 122 can be contained within cavities 132 of the links 115, which can permit the links 115 to rotate around the axles 122. Referring to FIG. 5, the axles 122, the cams 128 and the cam springs 130 are shown without the links 115 for clarity. Referring to FIG. 6, an example of a cam 128 is shown. The cam 128 can include one or more securing channels 134 and one or more cam active surfaces 136, which can include one or more ridges 138. The cam 128 may also have a first wall 140, a second wall 142 and an aperture 143, which can receive the axles 122.

Referring now to FIGS. 4-6, a portion of the cam springs 130 may be secured to the cams 128 through the securing channels 134. For example, referring to FIG. 4 in particular, the cam spring 130 positioned closer to the bottom of the drawing may be secured to the securing channels 134 of two cams 128. Here, this portion of the cam springs 130 may remain substantially secured in the securing channels 134 at all times.

Another portion 144 of the cam springs 130 may ride along the cam active surfaces 136 of the cams 128. As an example, the portion 144 of the cam spring 130 can be positioned against the first wall 140, and this can be a dwell position or a pre-slope position. Also, the rotation at this state can be considered zero degrees. As the flip portion 110 is moved from the base portion 112, the portion 138 of the cam spring 130 can move away from the first wall 140 and can ride along the cam active surface 136 towards the ridge 138. As it rides over the ridge 138, the portion 144 of the cam spring 130 can be forced away from the cam active surface 136. In particular, the portion 144, which may also be referred to as a first end, can be forced towards a corresponding second end 146 (see FIG. 5).

Eventually, the portion 144 of the cam spring 130 can overcome the ridge 138, and when it does, a feedback detent can be produced. For example, the portion 144 can ride along the cam active surface 136 until it moves against the second wall 142. This positioning can also be a dwell position, or a post-slope position. As noted earlier, the movement of the portion 144 of the cam spring 130 can occur when the links 115 are rotated. As such, the feedback detent can be produced when the links 115 rotate between pre-slope and post-slope dwell positions. These dwell positions can also correspond to the plurality of positions that the flip portion 110 may rest in when it is moved away from the base portions 112.

Referring to FIG. 4, the cam spring 130 positioned closer to the top of the drawing can be secured in the securing channels 134 of two cams 128, i.e., the cams 128 positioned closer to the top of the drawing. These cams 128 can be positioned within a first link 115, or the link 115 closer to the top of the drawing. In addition, the portions 144 of this cam spring 130 can ride along the cam active surfaces 136 of the cams 128 that are positioned closer to the bottom of the drawing. This cam spring 130 can also be fed through the apertures 143 of these cams 128, and these cams 128 can be positioned within a second link 115, or the link 115 that is closer to the bottom of the drawing.

Although the preceding figures have presented examples of various components to enable the flexible hinge 114 to operate, it is understood that the invention is not so limited. Those of skill in the art will appreciate that any other suitable structure can be used in the flexible hinge 114.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A flip-type portable electronic device, comprising:
a base portion;
a flip portion; and
a flexible hinge that couples the flip portion to the base portion, wherein the flexible hinge includes a plurality of interlocking links that rotate about a plurality of axles contained within the flexible hinge and the interlocking links rotate independently of one another and wherein the rotation of the interlocking links allows the flip portion to rotate with respect to the base portion.

2. The device according to claim 1, wherein the flip portion may remain in any one of a plurality of positions as it rotates with respect to the base portion and wherein each position that the flip portion may remain in corresponds to one of a plurality of dwell positions that each link rotates between.

3. The device according to claim 2, wherein the dwell positions are either pre-slope positions or post-slope positions.

4. The device according to claim 3, wherein a feedback detent is produced when the link rotates between a pre-slope dwell position and a post-slope dwell position.

5. The device according to claim 1, wherein the flip-type electronic device is a mobile communications unit and the base portion includes a keypad and the flip portion includes a display.

6. The device according to claim 1, wherein in a first state of rotation, one end of the flip portion rests against the base portion and an opening is formed between a second end of the flip portion and the base portion that receives a mechanism that holds the portable electronic device.

7. The device according to claim 1, wherein the flexible hinge further includes a plurality of cam springs and cams and wherein the cam springs are coupled to the axles and the cams.

8. The device according to claim 7, wherein the cam springs are coupled to the cams such that a cam spring is secured to two first cams and rides along a cam active surface of two second cams, wherein the first cams are positioned in a first link and the second cams are positioned in a second link.

9. The device according to claim 8, wherein the cam active surfaces include a ridge over which the cam springs ride and wherein a first end and a second end of the cam springs are forced towards one another as the cam springs ride over the ridges of the cam active surfaces.

10. The device according to claim 7, wherein ends of the axles are contained within cavities of the links and the links rotate around the axles contained within their cavities.

11. The device according to claim 1, wherein the links include a shell portion and an engagement portion, wherein the engagement portion of a first link fits within the shell portion of a second link.

12. The device according to claim 1, wherein the flip portion rotates about 155 degrees with respect to the base portion and each link rotates about 31 degrees.

13. A flexible hinge, comprising:
a plurality of links, wherein the links include a shell portion and an engagement portion, wherein the engagement portion of a first link fits within the shell portion of a second link;
a plurality of cams having cam active surfaces; and
a plurality of cam springs coupled to the links and to a plurality of axles, wherein the cam springs ride along the cam active surfaces, wherein the links rotate around the axles a number of degrees as the cam springs ride along the cam active surfaces and wherein the rotation of the links enables the links to move between open and closed positions.

14. The hinge according to claim 13, wherein the cam springs are coupled to the cam springs such that a cam spring is secured to two first cams and rides along the active surface of two second cams, wherein the first cams are positioned in a first link and the second cams are positioned in a second link.

15. The hinge according to claim 14, wherein the cam active surfaces include a ridge over which the cam springs ride and wherein a first end and a second end of the cam springs are forced towards one another as the cam springs ride over the ridges of the cam active surfaces.

16. The hinge according to claim 13, wherein the cams include an aperture and the cam springs are positioned within the apertures of the cams.

17. A flip-type portable electronic device, comprising:
a base portion;
a flip portion; and
a flexible hinge that couples the flip portion to the base portion and enables the flip portion to rotate a number of degrees with respect to the base portion, wherein the flexible hinge has a plurality of links in which each link rotates a number of degrees such that the total sum of the degrees of rotation of the links at least substantially equals the number of degrees that the flip portion rotates.

18. The device according to claim 17, wherein the base portion includes a keypad and the flip portion includes a display.

19. The device according to claim 17, wherein the flexible hinge includes a plurality of axles around which the links rotate and each link generates a feedback detent as the links rotate about the axles.

20. The device according to claim 17, wherein in a first state of rotation, one end of the flip portion rests against the base portion and an opening is formed between a second end of the flip portion and the base portion that receives a mechanism that holds the portable electronic device.

21. The device according to claim 17, wherein the flip portion may remain in any one of a plurality of positions as it rotates with respect to the base portion and wherein each position that the flip portion may remain in corresponds to one of a plurality of dwell positions that each link rotates between.
